(19) United States
(12) Patent Application Publication
(10) Pub. No.: US 2002/0147010 A1
(43) Pub. Date: Oct. 10, 2002

(54) Unsolicited paging response apparatus and method

(75) Inventors: Agustin Salguero Cruz, Saltillo (MX); Francisco Alessio Lopez Garcia, Saltillo (MX)

Correspondence Address: Mark V. Muller, Jenkens & Gilchrist, P.C., 3200 Fountain Place, 1445 Ross Avenue, Dallas, TX, 75202-2799, US

(73) Assignee: Telefonaktiebolaget L M Ericsson (publ)

(21) Appl. No.: 09/829,062

(22) Filed: Apr. 9, 2001

(51) Int. Cl. H04Q 7/20

(52) U.S. Cl. 455/426; 455/428; 455/552

(57) ABSTRACT

In an unsolicited page response scenario within a telecommunications network, a control channel access indicator with an unsolicited paging response is set to designate a digital control channel to indicate that a page validation must occur at the VLR connected to the satellite MSC receiving the message. If the indicator is not present or its value is set to designate an analog control channel, the page validation occurs at a BSC connected to the satellite MSC receiving the message. When the network is a TDMA network that has adopted the GPRS technology solution, the control channel access indicator is set to designate an analog control channel to indicate that the page order search should be conducted in the TDMA paging stack of the receiving satellite MSC. If the indicator is set to designate a digital control channel, then the search will be performed in the GPRS stack of the receiving satellite MSC. Using the control channel indicator avoids unnecessary searching, saving time and resources in the location process, and increases the likelihood of successful call delivery.

### BACKGROUND OF THE INVENTION

1. Technical Field

The invention relates generally to methods and apparatus for managing an unsolicited paging response in a mobile telecommunication system. More particularly, the invention relates to a method and apparatus for using a control channel access indicator during an unsolicited paging response operation.

2. History of Related Art

Currently, the American National Standards Institute (ANSI)-41D telecommunications standard defines the unsolicited paging response operation as follows: “This operation is used by a border Mobile Switching Center (MSC) to notify neighboring MSCs that an unsolicited or unexpected page response has been received from a Mobile Station (MS), that the MS's presence in the border MSC has been confirmed, and that a Temporary Location Directory Number (TLDN) has been assigned.” This situation occurs when a serving MSC issues a page order toward a mobile station, and another (e.g., border) MSC receives a page response from the paged mobile station. The border MSC must then search among all of the MSCs sharing the same paging area (satellite or neighboring MSCs), for the MSC that originated the page order (i.e., the originating MSC). In this unsolicited paging response scenario, each of the satellite MSCs contacted by the border MSC must determine whether they originated the page order. In the meantime, the subscriber that originated the call, i.e., the A subscriber, must in turn wait for a response from the other side of the call link, i.e., from the B subscriber, while the search is completed.

There are several problems associated with this unsolicited response scenario. Because the air interface established for the A subscriber is time limited, the search time required to locate the page originator is critical. The chances of reaching a time out to terminate the A subscriber's air interface are usually greater than the chances of timely finding the B subscriber and completing the call. Thus, any activity that increases the searching process virtually ensures an unsuccessful call delivery.

These problems are magnified when the General Packet Radio Service (GPRS) solution is adopted within a Time Division Multiple Access (TDMA) wireless telecommunication network. With the implementation of the GPRS, the MSC receiving the unsolicited response does not know whether the page originated from a GPRS subscriber or a TDMA subscriber. Since each MSC must update one stack of page orders for GPRS subscribers, and another stack of page orders for non-GPRS subscribers, each satellite MSC must look for the original page order in a TDMA page order stack, and a GPRS page order stack.

Thus, the waiting time for the A subscriber that originated the call may be dramatically increased depending on the network configuration and the number of subscribers in each node, including roaming subscribers. This means that the time before the B subscriber answers cannot be accurately predicted, and the call setup time may be greatly increased. Since each satellite MSC needs to look for the page order in two different stacks, the administration and control of this search is very time consuming. Due to the double searching process, the likelihood of an unsuccessful call delivery is almost assured.

Therefore, what is needed is an apparatus and method that provides information to the satellite MSCs in order to speed up the searching process and increase the possibility of a successful call delivery. Such an apparatus and method should avoid the use of network resources to look for the originating MSC.

### SUMMARY OF THE INVENTION

The present invention relates to an apparatus and method for using a control channel access indicator during an unsolicited response operation, including a Time Division Multiple Access (TDMA) network which has adopted the General Packet Radio Service (GPRS) technology solution. The invention includes an indicator embedded in the unsolicited response message which lets the satellite MSCs, including the serving MSC, know from which control channel the page order originated. Using this indicator, each satellite MSC can quickly determine the proper location in which to search for the page order. With this solution, the subscriber is located more quickly and the search utilizes fewer processor resources than the current method, thereby increasing the possibility of a successful call delivery.

In the regular TDMA scenario (without using GPRS), the control channel access indicator is set to digital to indicate that the page validation (i.e., searching for and locating the page order) must occur at the Visitor Location Register (VLR). If the indicator is not present or its value is set to designate an analog control channel, the page validation (i.e., searching for and locating the page order) must occur at the Base Station Controller (BSC).

In the TDMA network which has adapted the GPRS technology solution, the control channel access indicator indicates to the satellite MSCs whether the search for the page order (i.e., validation) should be conducted in the regular paging stack or the GPRS stack. More particularly, if the control channel indicator is set to analog, then the search will be performed in the regular paging stack. If the control channel indicator is set to digital, then the search will be performed in the GPRS stack. Thus, using the control channel indicator avoids searching both stacks, thereby saving time and resources for the location process.

### BRIEF DESCRIPTION OF THE DRAWINGS

A more complete understanding of the structure and operation of the present invention may be had by reference to the following detailed description when taken in conjunction with the accompanying drawings, wherein:

FIG. 1 is a prior art event diagram illustrating the performance of different network entities during an unsolicited response operation as defined in the ANSI-41D standard;

FIG. 2 is a prior art event diagram illustrating the interaction between network entities during an unsolicited response operation using General Packet Radio Service (GPRS) and TDMA technology;

FIG. 3 is an event diagram illustrating the performance of different network entities during an unsolicited response operation using the control channel access indicator of the present invention in a TDMA network mode; and

FIG. 4 is an event diagram illustrating the interaction between network entities during an unsolicited response operation using the control channel access indicator of the present invention in a TDMA network which has adapted the GPRS technology solution.

### DETAILED DESCRIPTION OF PRESENTLY PREFERRED EXEMPLARY EMBODIMENTS

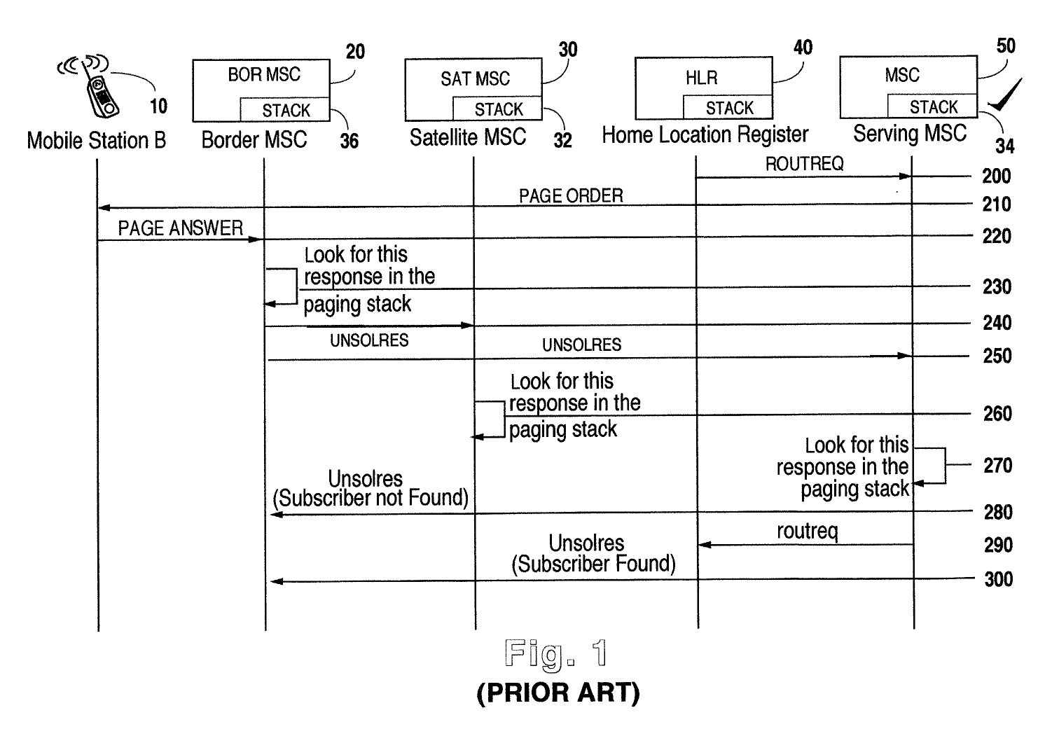

FIG. 1 illustrates ANSI-41D standard operations for a prior art unsolicited paging response operation in a typical network scenario. In this illustration of the prior art, a routing request message is sent from the Home Location Register (HLR) 40 to the Serving MSC 50 in step 200. The Serving or originating MSC 50 then sends a page order to the Mobile Station B (MS-B) 10 in step 210. In the unsolicited response scenario, the MS-B 10 then answers the page order in step 220 to the Border MSC 20, instead of the Serving MSC 50. At this time, the Border MSC 20 will look unsuccessfully for the paging order in its paging stack 36 in step 230 since this page response was unsolicited. The Border MSC 20 must then look for the originating MSC among all of the MSCs sharing the same paging area (the serving MSC 50 and the MSC 30 are both defined as satellites in the Border MSC 20 profile). The Border MSC 20 utilizes the unsolicited response message in steps 240 and 250 to notify neighboring MSCs (30 and 50) not only of receipt of the unsolicited response, but also providing confirmation of the MS-B's 10 presence within its coverage area, and the assignment of a TLDN to the MS-B 10.

Each one of the network entities (MSCs 30 and 50) participating in the unsolicited response operation then looks for the page order in their paging stacks 32,34 to discover whether they originated the page order in steps 260 and 270. In step 280 of FIG. 1, the satellite MSC 30 did not find the subscriber in its paging stack (and a corresponding “subscriber not found” message is sent back to the MSC 20). However, the serving MSC 50 does find the subscriber in its paging stack 34 and sends the route request response to the HLR in step 290 and an unsolicited response response “subscriber found” message to the Border MSC in step 300. Meanwhile, the A subscriber that originated the call is waiting for the B-subscriber to answer at the other side of the call link. Since the air interface for the A subscriber is time limited, the possibility of reaching a time out in the air interface towards the A subscriber may be greater than the possibility of timely finding the B subscriber and completing the call. Thus, the time required to look for the page originator is critical, and any information given to the Border MSC which speeds the searching process increases the possibility of a successful call delivery and avoids the use of network resources to look for the originator.

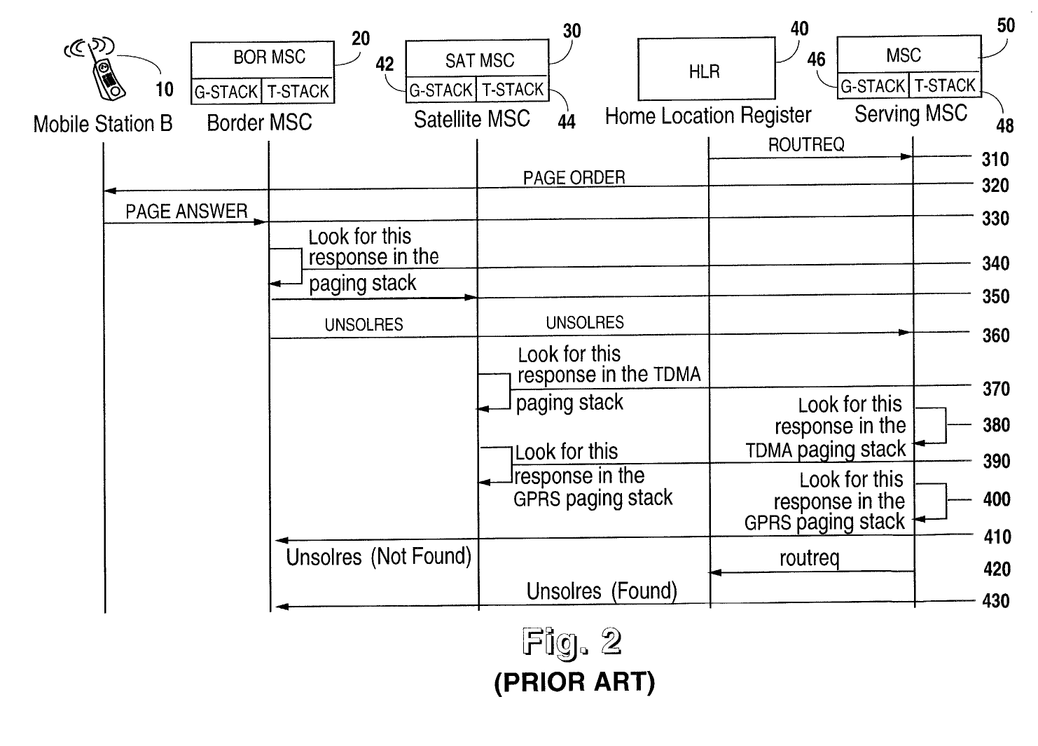

FIG. 2 illustrates the prior art interaction between network entities during an unsolicited response operation using GPRS and TDMA technology. The problem introduced with the implementation of GPRS technology is that the MSC does not know whether the page order was originated by a GPRS subscriber or a TDMA subscriber. Thus, the satellite MSCs must each look for the page order in both their GPRS and TDMA page order stacks: 42,44,46, and 48.

Steps 310 through 360 correspond directly to steps 200 through 250 in prior art FIG. 1, wherein the unsolicited response message is sent by the Border MSC to the satellite MSCs 30,50 (including the serving/originating MSC). However, the problem becomes more complex with the GPRS implementation. In this scenario, the MSCs that have implemented GPRS functionality maintain a separate paging stack 42,46 for the GPRS subscribers. Thus, all of the MSCs (satellite and serving) 30,50 receiving an unsolicited response message must look for the page order in both the TDMA page order stack (i.e., the T-STACK 44,48) in steps 370 and 380, and the GPRS page order stack (i.e., the G-STACK 42, 46) in steps 390 and 400, to find the paging order. This prior art implementation continues in step 410, wherein the satellite MSCs 30, other than the serving MSC 50, send an unsolicited response (“subscriber not found”) message back to the Border MSC. In step 420, the serving MSC 50 sends a routing request response to the HLR 40, and in step 430, the serving MSC 50 sends an unsolicited response (“subscriber found”) message to the Border MSC 20.

In this scenario, the MSCs 30, 50 do not know whether the B subscriber is a GPRS subscriber or a TDMA subscriber, so they must search both page order stacks 42,44,46 and 48. Meanwhile, the A subscriber that originated the call is waiting for the B subscriber to answer on the other side of the call link under the air interface time constraints previously described. However, in this scenario, there may be additional waiting time depending on the network configuration and the number of subscribers served by each node (including roaming subscribers). This means that the time required for the B subscriber to answer is unknown, and the call setup time may be greatly increased. Again, the time required to locate the page originator is critical, and any activity which increases the searching process time almost ensures unsuccessful call delivery. This possibility is increased dramatically because of the double search process wherein each satellite MSC must look for the page order in two different components, i.e., the VLR and the BSC. As noted previously, since the administration and control of this search is very time-consuming, any information which can be given to the Border MSC (and/or satellite MSCs) to hasten the searching process will increase the likelihood of a successful call delivery.

The present invention utilizes a control channel access indicator as a mechanism to notify other nodes where to more efficiently search for the subscriber (and the originator of the paging order), or to request the proper node to do the search and where that node should conduct the search. In other words, the indicator tells the satellite MSCs (including the serving MSC) which control channel originated the page order. Using this indicator, each MSC is able to determine where to request the search process (e.g., the BSC), and to avoid searching for (i.e., validating) the page order in a different network entity (e.g., the VLR), or in different page order stacks.

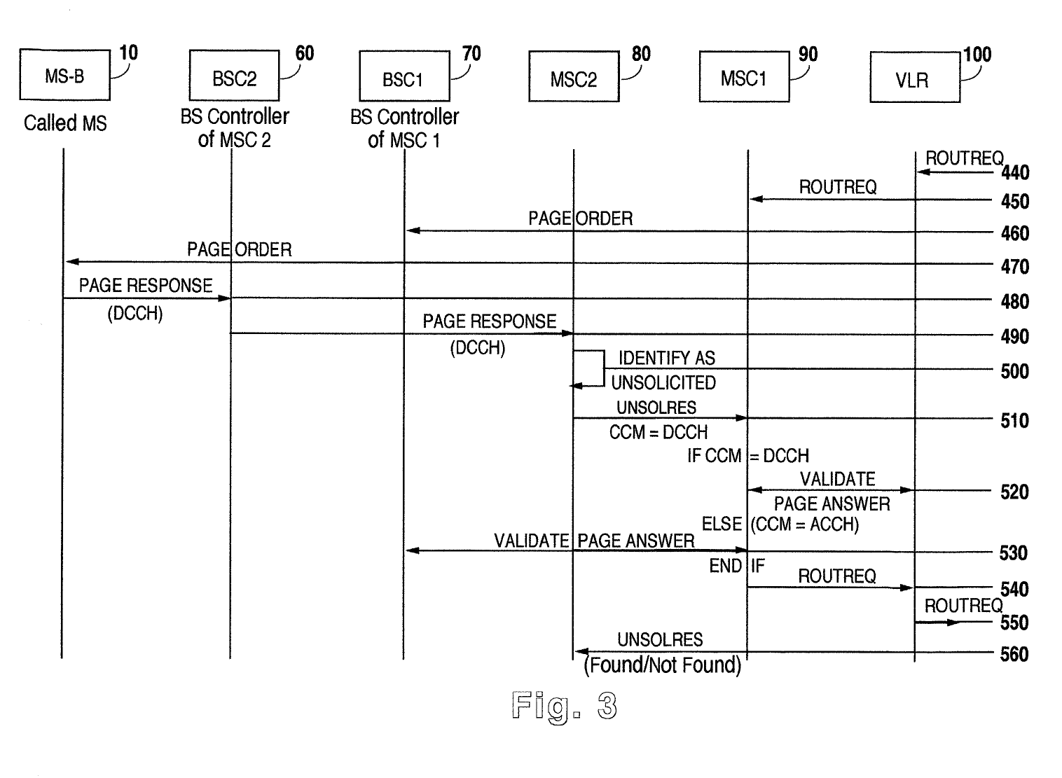

Operation of the unsolicited response at the network level is illustrated in FIG. 3. Steps 440 through 470 illustrate the elements of a regular call and the relationships among the network entities involved in sending a page order to the B subscriber (hereinafter referred to as “MS-B” 10). The page response in a Digital Control Channel (DCCH) of the MS-B 10 is received in the BS Controller of MSC2 60 (i.e., BSC2) instep 480. This page answer, containing the access indicator for the control channel set to designate a DCCH, is forwarded to the MSC2 80 in step 490.

As the MSC2 80 did not originate the page order, the answer is identified as an unsolicited paging response by the MSC2 80 in step 500. As a result, the MSC2 80 triggers an unsolicited response message to all satellite MSCs, including MSC1 90, with the control channel access indicator set to DCCH in step 510. The MSC1 90 then has two options regarding where to look for the page order: first in the VLR 100, and second in the BSC1 70, and other BSCs that may be connected to MSC1 90 (not shown). According to the present invention, if the unsolicited response message 510 contains the control channel access indicator, and the indicator is set to 20 designate a digital control channel, i.e., DCCH (as illustrated in FIG. 3), then validation of the page order must occur at the VLR in electronic communication with the MSC1 90 in step 520. If the control channel access indicator is not present or its value is set to designate an analog control channel, validation of the page order must occur at the BSC1 70 in electronic communication with the MSC1 90 (assuming the BSC1 70 is the only BSC connected to the MSC1 90) in step 530. Thus, implementation of the control channel access indicator means that the MSC1 90 is not required to search in both the VLR 100 and the BSC1 70. When the subscriber is located, the MSC1 90 sends a routing request response to the VLR 100 in step 540, and from the VLR 100 to the HLR instep 550. Finally, in order to close the transaction with the MSC2 80, the MSC1 90 sends the MSC2 80 the unsolicited response message in step 560 so that the MSC2 80 can determine whether the page originator was located.

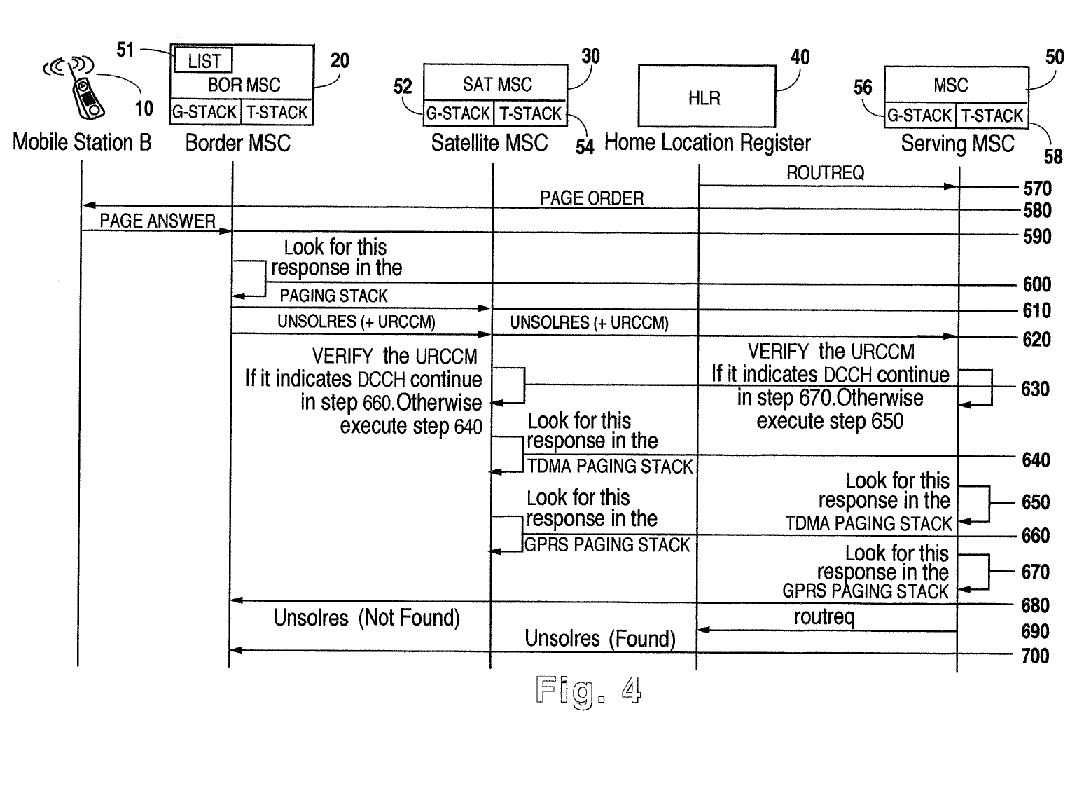

FIG. 4 illustrates the control channel access indicator method of the present invention during an unsolicited response operation in a TDMA network which has adopted the GPRS technology solution. In step 570, a routing request message is sent by the HLR 40 to the MSC 50. A page order request is sent in step 580 from the MSC 50 to the MS-B 10 to determine if the MS-B 10 is still in its coverage area. The MS-B 10 answers the page order, but responds to a different MSC, i.e., the Border MSC 20 in step 590. The Border MSC 20 looks for the page order in its paging list 51 in step 600 and determines that the page order corresponding to the page answer was not originated for the Border MSC 20. The Border MSC 20 then directs an unsolicited response message including an unsolicited response control channel mode (URCCM) parameter (i.e., the control channel access indicator) to each one of the MSCs (i.e., both satellite MSCs 30 and serving MSC 50) sharing the paging area in steps 610 and 620. Using this parameter, the MSCs (30 and 50) receiving the unsolicited response message will know which stacks to search for the page order. Thus, this parameter is verified in step 630 in order to determine where the page order search will be performed. More specifically, if the URCCM is received with the value indicating that the page answer was received in the analog control channel, then the search will be performed in the TDMA paging stacks 54, 58 in steps 640 and 650. Alternatively, if the URCCM indicates that the page answer was received in the DCCH, then the search will be performed in the GPRS stacks 52, 56 in steps 660 and 670. For example, an Unsolicited Response Control Channel Mode value of +1 might indicate an analog control channel, (i.e., from the BSC), and a value of +2 might indicate a DCCH, (i.e., from the VLR). The use of this indicator improves the performance of each node (i.e., MSC, VLR, BSC) by avoiding unnecessary work for each entity.

Using the URCCM parameter also eliminates the need to search both stacks, saving additional time and resources in the location process. In step 680, the satellite MSC 30 answers the unsolicited response message received from the Border MSC 20 with an unsuccessful result, indicating that it has not located the page order. The serving MSC 50 answers the routing request message to the HLR 40 in step 690 along with a TLDN, indicating that the serving MSC 50 has found MS-B 10. The serving MSC 50 also answers the unsolicited response message received from the Border MSC 20 in step 700 with a successful result, indicating that the serving MSC 50 initiated the page order, and was therefore the “originating” MSC.

Although the invention has been described with reference to specific embodiments, this description is not meant to be construed in a limited sense. The various modifications of the disclosed embodiments, as well as alternative embodiments of the invention, will become apparent to persons skilled in the art upon reference to the description of the invention. It is, therefore, contemplated that the appended claims will cover such modifications that fall within the scope of the invention, or their equivalents.

What is claimed is:

1. An apparatus for responding to a paging order from a Serving Mobile Switching Center (Serving MSC), comprising:
a Satellite MSC adapted to receive an unsolicited paging response message including a control channel access indicator, wherein the control channel access indicator is used by the Satellite MSC to identify the Serving MSC.

2. The apparatus of claim 1, wherein the control channel access indicator designates a digital control channel.

3. The apparatus of claim 2, further comprising:
a Location Register in electronic communication with the Satellite MSC, wherein the paging order is validated using the Location Register.

4. The apparatus of claim 3, wherein the Location Register is a Visitor Location Register.

5. The apparatus of claim 1, wherein the control channel access indicator designates an analog control channel.

6. The apparatus of claim 5, further comprising:
a Base Station Controller in electronic communication with the Satellite MSC, wherein the paging order is validated using the Base Station Controller.

7. The apparatus of claim 1, wherein the Satellite MSC operates within a Time Division Multiple Access (TDMA) network using a General Packet Radio Service (GPRS), further comprising:
a Time Division Multiple Access (TDMA) paging stack and a GPRS paging stack.

8. The apparatus of claim 7, wherein the control channel access indicator designates a digital control channel, and wherein the paging order is validated in the GPRS stack.

9. The apparatus of claim 7, wherein the control channel access indicator designates an analog control channel, and wherein the paging order is validated in the TDMA stack.

10. A method of responding to a paging order from a Serving Mobile Switching Center (Serving MSC), comprising the steps of:
sending a paging order from the Serving MSC;
receiving a page response;
identifying the page response as an unsolicited page response; and
sending an unsolicited paging response message including a control channel access indicator to a Satellite MSC.

11. The method of claim 10, wherein the control channel access indicator designates a digital control channel.

12. The method of claim 11, wherein a Location Register is in electronic communication with the Satellite MSC, further comprising the steps of:
validating the paging order using the Location Register.

13. The method of claim 12, wherein the Location Register is a Visitor Location Register.

14. The method of claim 10, wherein the control channel access indicator designates an analog control channel.

15. The method of claim 14, wherein a Base Station Controller is in electronic communication with the Satellite MSC, further comprising the steps of:
validating the paging order using the Base Station Controller.

16. The method of claim 10, wherein the Satellite MSC operates within a Time Division Multiple Access (TDMA) network using a General Packet Radio Service (GPRS) and includes a Time Division Multiple Access (TDMA) paging stack and a GPRS paging stack.

17. The method of claim 16, wherein the control channel access indicator designates a digital control channel, further comprising the step of:
validating the paging order in the GPRS stack.

18. The method of claim 16, wherein the control channel access indicator designates an analog control channel, further comprising the step of:
validating the paging order in the TDMA stack.

19. An apparatus for responding to a paging order from a Serving Mobile Switching Center (Serving MSC), comprising:
a Satellite MSC adapted to receive an unsolicited paging response message excluding a control channel access indicator, wherein absence of the control channel access indicator is used by the Satellite MSC to identify the Serving MSC.

20. The apparatus of claim 19, further comprising:
a Base Station Controller in electronic communication with the Satellite MSC, wherein the paging order is validated using the Base Station Controller.

21. The apparatus of claim 19, wherein the Satellite MSC operates within a Time Division Multiple Access (TDMA) network using a General Packet Radio Service (GPRS), further comprising:
a Time Division Multiple Access (TDMA) paging stack and a GPRS paging stack.

22. The apparatus of claim 21, wherein the paging order is validated in the TDMA stack.

23. A method of responding to a paging order from a Serving Mobile Switching Center (Serving MSC) in electronic communication with a Base Station Controller at a Satellite MSC, comprising the steps of:
sending a paging order from the Serving MSC;
receiving a page response;
identifying the page response as an unsolicited page response; and
sending an unsolicited paging response message excluding a control channel access indicator to the Satellite MSC;
determining that the control channel access indicator is absent; and
validating the paging order using the Base Station Controller.

24. The method of claim 23, wherein the Satellite MSC operates within a Time Division Multiple Access (TDMA)network using a General Packet Radio Service (GPRS) and includes a Time Division Multiple Access (TDMA) paging stack and a GPRS paging stack.

25. The method of claim 24, further comprising the step of: validating the paging order in the TDMA stack.

26. A method of responding to a paging order from a Serving Mobile Switching Center (Serving MSC) at a Satellite MSC, wherein the Satellite MSC operates within a Time Division Multiple Access (TDMA) network using a General Packet Radio Service (GPRS) and includes a Time Division Multiple Access (TDMA) paging stack, comprising the steps of:
sending a paging order from the Serving MSC;
receiving a page response;
identifying the page response as an unsolicited page response; and
sending an unsolicited paging response message excluding a control channel access indicator to the Satellite MSC;
determining that the control channel access indicator is absent; and
validating the paging order in the TDMA stack.
